(19) United States
(12) Patent Application Publication
(10) Pub. No.: US 2007/0047394 A1
(43) Pub. Date: Mar. 1, 2007

(54) Method and apparatus for testing a dual layer DVDdisk

(75) Inventor: Shun-Chin Lin, Jhongli City (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/501,688

(22) Filed: Aug. 10, 2006

(30) Foreign Application Priority Data
Aug. 26, 2005 (TW) 94129363

(51) Int. Cl. G11B 21/08

(52) U.S. Cl. 369/30.04

(57) ABSTRACT

A method and apparatus for testing a dual layer DVD+R disk are disclosed. The disk includes a first recording area and a second recording area. First, read data distribution of the disk from the first recording area. Next, determine if the disk is blank, and if the disk is blank, format the disk and logically divide the disk into a number of sessions. Read detailed information of the sessions from the second recording area if the disk is not blank. Afterward, write writing data into a selected session to test the disk. Finally, close the selected session and write the detail information of the selected session into the second recording area.

This application claims the benefit of Taiwan application Serial No. 94129363, filed Aug. 26, 2005, the subject matter of which is incorporated herein by reference.

### BACKGROUND OF THE INVENTION

1. Field of the Invention

The invention relates in general to a method and apparatus for testing a disk, and more particularly to a method and apparatus for testing a dual layer DVD+R disk.

2. Description of the Related Art

Recently, digital versatile disk (DVD) series products with high storage volume and high data storage density are greatly produced due to complication of software and requirement for high audio/video quality. DVD+R dual layer disks are one of various DVD disk specifications.

The dual layer DVD+R disk is a storage medium with two recording layers. Referring to FIG. 1, a schematic diagram of a dual layer DVD+R disk is shown. The dual layer DVD+R disk has two layers L0 and L1 for recording data. Compared to the storage medium with only one layer, the dual layer DVD+R disk can expend its storage volume by the extra storage layer.

When the dual layer DVD+R disk is tested, two recording layers are individually recorded to test quality of the disk under different situations. However, if the recording layer L1 is recorded first, in the dual layer DVD+R specification, the front area of the recording layer L1, that is, the recording layer L0, cannot be recorded any more even it records no data. Under this situation, the disk whose recording layer L1 has been recorded cannot be used again, thereby increasing test cost.

### SUMMARY OF THE INVENTION

It is therefore an object of the invention to provide a method and apparatus for testing a dual layer DVD+R disk. In the test process, it is not needed to sequentially write data into the disk and the purpose of using the disk repeatedly can be achieved.

The invention achieves the above-identified object by providing a method for testing a dual layer DVD+R disk. The disk includes a first recording area and a second recording area. The method includes reading data distribution of the disk from the first recording area; determining if the disk is blank, and if the disk is blank, formatting the disk and logically dividing the disk into a plurality of sessions; and if the disk is not blank, reading detailed information of the sessions from the second recording area; writing a piece of writing data into a selected session of the sessions to test the disk; and closing the selected session and writing the detail information of the selected session into the second recording area.

The invention achieves the above-identified object by providing an apparatus for testing a dual layer DVD+R disk. The disk includes a first recording area and a second recording area. The apparatus includes an optical disk drive and a host. The optical disk drive is for reading/writing the disk. The host is for controlling the optical disk drive to read/write the disk. The host controls the optical disk drive to read data distribution of the disk from the first recording area so as to determine if the disk is blank, and the optical disk drive formats the disk and logically divides the disk into a plurality of sessions if the disk is blank. The optical disk drive reads detailed information of the sessions from the second recording area and transmits the detailed information to the host, the host controls the optical disk drive to write a piece of writing data into a selected session of the sessions to test the disk and then controls the optical disk drive to close the selected session, and the optical disk drive writes the detailed information of the selected session into the second recording area.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a schematic diagram of a dual layer DVD+R disk.

FIG. 2 is a layout diagram of a dual layer DVD+R disk.

FIG. 3 is a schematic diagram of an apparatus for testing a dual layer DVD+R disk according to a preferred embodiment of the invention.

FIG. 4 is a flow chart of a method for testing a dual layer DVD+R disk according to the preferred embodiment of the invention.

FIG. 5 is a schematic diagram of a session of a disk.

### DETAILED DESCRIPTION OF THE INVENTION

Referring to FIG. 2, a layout diagram of a dual layer DVD+R disk is shown. The disk 200, a dual layer DVD+R disk, includes recording layers L0 and L1. The recording layer L0 includes an inner drive area a11, a lead-in area a21, a data area a31, a middle zone a41 and an outer drive area a51. The recording layer L1 includes an inner drive area a12, a lead-out area a22, a data area a32, a middle zone a42 and an outer drive area a52.

In the embodiment, the inner drive areas a12 and all include a first recording area and a second recording area so as to record data distribution of the disk 200. For example, the first recording area is a table-of-content (TOC) area (not shown in the figure) and the second recording area is a recorded area indicator (RAI) area (not shown in the figure). The TOC area is for recording general information, such as an initial address, a number, and an open or close state, of each session in the data areas a31 and a32. As the dual layer DVD+R disk 200 has very large storage volume, the TOC area is for recording session general information while the RAI area is for recording more detailed session information, such as data addresses.

The data areas a31 and a32 are for recording data and distribution of the data is recorded in the TOC area and RAI area. The lead-in area a21 and lead-out area a22 are for determining a start point and an end point of the data. No data is recorded in the outer drive areas a51 and a52 as well as the middle zones a41 and a42.

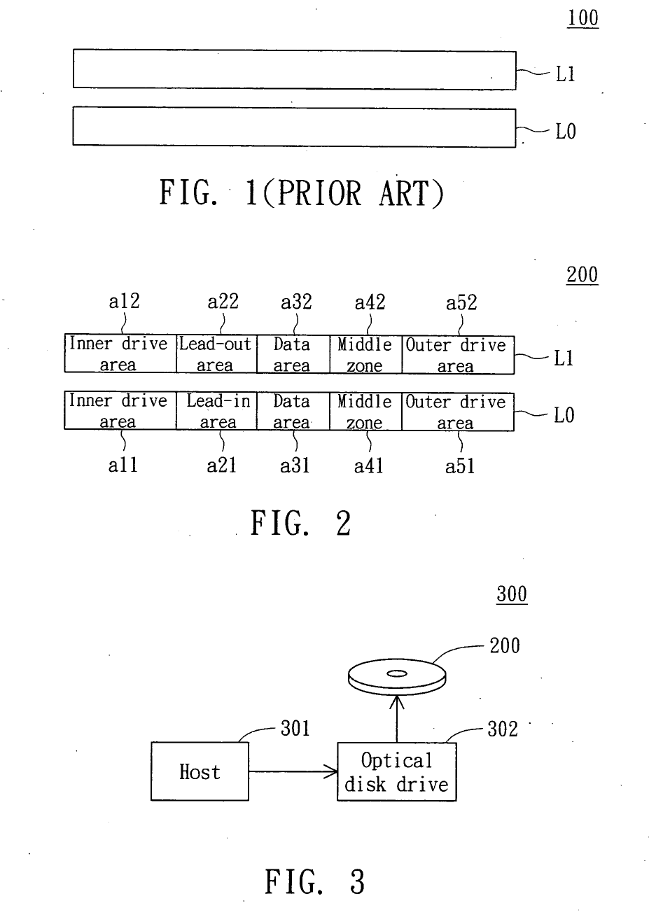

Referring to FIG. 3, a schematic diagram of an apparatus for testing a dual layer DVD+R disk according to an embodiment of the invention is shown. The test apparatus 300 includes a host 301 and an optical disk drive 302. The optical disk drive 302 is for reading/writing the disk 200. The host 301 is for controlling the optical disk drive 302 to read/write the disk 200. The operation of the host 301 and optical disk drive 302 is shown as below.

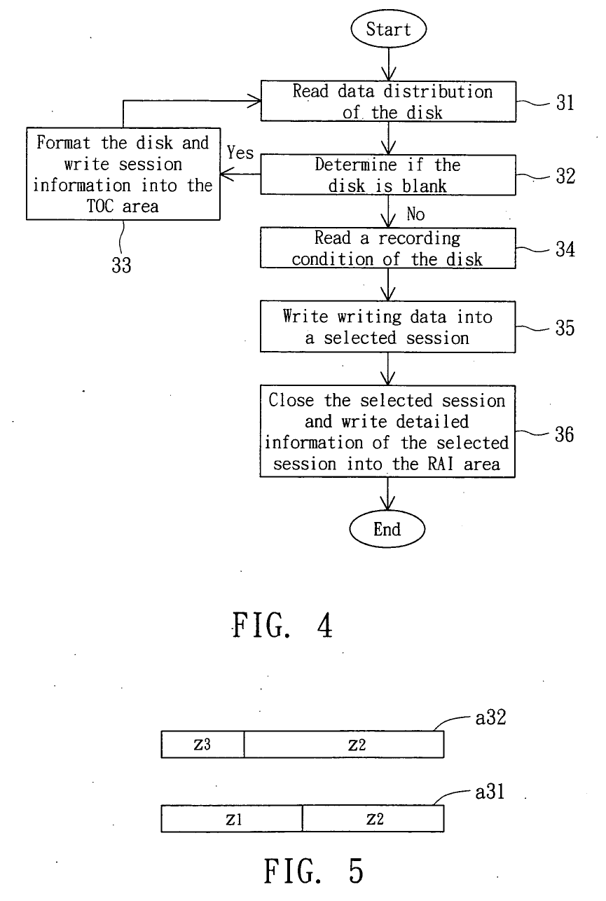

Referring to FIG. 4, a flow chart of a method for testing a dual layer DVD+R disk according to the preferred embodiment of the invention is shown. First, in step 31, the optical disk drive 302 reads data distribution of the disk 200 from the TOC area. Following that, in step 32, the host 301 determines if the disk 200 is blank. If the disk 200 is blank, the optical disk drive 302 formats the disk 200, logically divides the disk 200 into a number of sessions, writes data of the sessions into the TOC area, and returns to the step 31, as shown in step 33. If the disk 200 is not blank, in step 34, the host 301 communicates with the optical disk drive 302 to obtain detailed information of each session from the RAI area. Afterward, in step 35, the optical disk drive 302 writes writing data into a selected session to test the disk 200. Finally, in step 36, the host 301 controls the optical disk drive 302 to close the selected session and write the detailed information of the selected session into the RAI area.

In the step 31, the host 301 communicates with the optical disk drive 302 via an advanced technology attachment packet interface (ATAPI) to obtain the data distribution of the disk 200. In the step 33, the host 301 controls the optical disk drive 302 to format the disk 200 according to a designer-defined command. For example, the information written into the TOC area includes a start point and an end point of a session, a session number and a session state.

In the step 33, a format operation is performed to logically divide the data areas a32 and a31 into a number of sessions. Referring to FIG. 5, a schematic diagram of a session of the disk 200 is shown. In the embodiment, the data areas a32 and a31 are logically divided into sessions Z1, Z2 and Z3 and thus data can be freely written into any session without need to be written sequentially. The disk 200 has different linear speed for reading/writing an inner area and outer area. For example, the linear speed for reading/writing the outer area is larger. Therefore, the speed for reading/writing a session can be defined according to the position of each session.

In the step 34, the host 301 communicates with the optical disk drive 302 according to a designer-defined command to obtain session information and a recording condition of the disk 200. In the step 35, the data can be written by a parallel track path (PTP) or an opposite track path (OTP). In the step 35, the host 301 controls the optical disk drive 302 to write the writing data into the selected session via the ATAPI. In the step 36, the host 301 controls the optical disk drive 302 to close the selected session via the ATAPI.

In the method and apparatus for testing a dual layer DVD+R disk disclosed by the above-mentioned embodiment of the invention, the disk is logically divided into a number of sessions and the speed for reading/writing each session is defined according to the position of each session. Therefore, the writing/reading efficiency can be improved.

Besides, when testing the dual layer DVD+R disk, data needs not to be sequentially written into the disk as in the prior art method and can be freely written into any session to test the disk. Therefore, the issue that the disk with blank areas cannot be used in the prior art can be solved and the disk can be tested repeatedly to save test cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for testing a dual layer DVD+R disk, the disk comprising a first recording area and a second recording area, the method comprising:
reading data distribution of the disk from the first recording area;
determining if the disk is blank, and if the disk is blank, formatting the disk and logically dividing the disk into a plurality of sessions; and
reading detailed information of the sessions from the second recording area if the disk is not blank;
writing writing data into a selected session of the sessions to test the disk; and
closing the selected session and writing the detail information of the selected session into the second recording area.

2. The method according to claim 1, wherein the first recording area is a table-of-content (TOC) area.

3. The method according to claim 1, wherein the second recording area is a recorded area indicator (RAI) area.

4. The method according to claim 1, wherein in the step of formatting the disk, information of the sessions is written into the first recording area and a start point and an end point of each session is set.

5. The method according to claim 1, wherein in the step of writing writing data into a selected session of the sessions to test the disk, the writing data is recorded by a parallel track path (PTP).

6. The method according to claim 1, wherein in the step of writing writing data into a selected session of the sessions to test the disk, the writing data is recorded by an opposite track path (OTP).

7. An apparatus for testing a dual layer DVD+R disk, the disk comprising a first recording area and a second recording area, the apparatus comprising:
an optical disk drive, for reading/writing the disk; and
a host, for controlling the optical disk drive to read/write the disk;
wherein the host controls the optical disk drive to read data distribution of the disk from the first recording area so as to determine if the disk is blank, and the optical disk drive formats the disk and logically divides the disk into a plurality of sessions if the disk is blank;
wherein the optical disk drive reads detailed information of the sessions from the second recording area and transmits the detailed information to the host, the host controls the optical disk drive to write writing data into a selected session of the sessions to test the disk and then controls the optical disk drive to close the selected session, and the optical disk drive writes the detailed information of the selected session into the second recording area.

8. The apparatus according to claim 7, wherein the first recording area is a TOC area.

9. The apparatus according to claim 7, wherein the second recording area is a RAI area.

10. The apparatus according to claim 7, wherein the host controls the optical disk drive to write the writing data into the selected session by a parallel track path (PTP).

11. The apparatus according to claim 7, wherein the host controls the optical disk drive to write the writing data into the selected session by an opposite track path (OTP).

12. The apparatus according to claim 7, wherein after the optical disk drive formats the disk, the optical disk drive writes information of the sessions into the first recording area and sets a start point and an end point of each session.

13. The apparatus according to claim 7, wherein the host communicates with the optical disk drive via an advanced technology attachment packet interface (ATAPl) to obtain the data distribution of the disk.

14. The apparatus according to claim 7, wherein the host controls the optical disk to write the writing data into the selected session via an ATAPI.

15. The apparatus according to claim 7, wherein the host controls the optical disk drive to close the selected session via an ATAPI.
